(19) United States
(12) Patent Application Publication
(10) Pub. No.: US 2009/0299862 A1
(43) Pub. Date: Dec. 3, 2009

(54) ONLINE AD SERVING

(75) Inventors: Xiaofeng Fan, Redmond, WA (US); Helen J. Wang, Redmond, WA (US); John D. Dunagan, Bellevue, WA (US); Mansoor A. Malik, Bellevue, WA (US); Rajesh S. Batheja, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,460

(22) Filed: Jun. 26, 2008

Related U.S. Application Data
(60) Provisional application No. 61/058,213, filed on Jun. 3, 2008.

(51) Int. Cl. G06Q 30/00; G06F 9/44

(52) U.S. Cl. 705/14.73; 719/328

(57) ABSTRACT

Online ad hosting (e.g., hosting ads from one domain on a webpage from a different domain) is accomplished using a cross-domain frame (e.g., an inline frame (IFrame)), a secure inter-frame communications channel, and a source code interface (e.g., a set of application program interfaces (APIs)). That is, a cross-domain IFrame may be created in a host webpage, which can isolate an ad from the host webpage. An inter-frame communications channel may be utilized to communicate between the contents of the cross-domain frame and the host webpage. Further, a source code interface may be used to communicate a host's preferences for an ad's parameters and restrictions.

### REFERENCE TO RELATED APPLICATION

This application claims priority to and the benefit of U.S. Provisional Application Ser. No. 61/058,213 which was filed Jun. 3, 2008, entitled ONLINE AD SERVING, the entirety of which is hereby incorporated by reference as if fully set forth herein.

### BACKGROUND

In a computing environment, websites and associated webpages often host online advertisements, intended to be viewed by online users of the respective websites. Online advertisements typically come from a different domain than that of the hosting website. Online advertisers and hosting websites typically work with an ad syndicator, which takes calls for ads from the host, pulls ads from the advertiser, and then directs the ads to the host's website. Often, online ads have rich functionality, including an ability to expand and/or move about a webpage.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Typically, when a webpage wishes to display an online ad, the webpage (hosting webpage) can call to an ad syndicator, indicating specifications for an open ad-space in the host webpage. The ad syndicator can pull an ad from a catalogue of ads supplied by advertisers, which meets the specifications supplied by the host webpage. Typically, the ad syndicator will put the pulled ad directly into the host webpage, in such a way that the browser takes the ad as a part of the host webpage. When this occurs, the ad is often allowed to freely interact with the host webpage in order to provide for rich functionality, including changing its size and/or position on the host webpage. However, inserting the ad in this manner also grants the ad many if not all privileges that the host webpage may have in the browser. Unfortunately, malicious ads may also be inserted into the host webpage in this manner, creating an opportunity to damage a host website, or steal users' personal identifiable information. Additionally, a webpage host may be able to take advantage of an ad owner by manipulating the ad content inside the browser, such as by inflating the number of times an ad appears to have been clicked on by a user, for example.

As an example, it is not uncommon for a webmail system to host a third-party ad. The ad may be integrated by the ad syndicator in a way that allows the ad to freely expand out or fly around the host webpage. However, this ad also has a potential to view users' emails on the hosting page, and to steal user credentials from the host website's cookies, for example. From the perspective of protecting an ad owner, a host could charge an ad owner more where the host programmatically increases the number of times an ad appears to have been clicked on by a user.

Previous and current solutions to this ad serving security issue have limitations that may not make them as functional, or provide for extensive proprietary updates to user's, ad syndicator's, and advertiser's systems. In one such solution an ad created by the advertiser is sent by a third-party advertising vendor and put into a cross-domain frame or window of the host webpage, and the ad is isolated from the host webpage. However, there can be no client-side interaction with the host page, which may limit the ad's rich functionality. In another such solution, the ad created by the advertiser is pulled by the ad syndicator, transformed into pure text, and put into the host webpage. However, in this solution, the ad cannot contain executable code, which eliminates the ad's rich functionality. Other solutions utilize ad code scanning techniques, or “blacklisting” techniques that are designed to prohibit certain functions in the host webpage. However, these solutions may not be able to cover new malicious techniques, may block legitimate ads, and often require additional installs to browsers, or other ad syndication systems.

Techniques and systems are provided herein for securely serving online ads on a host webpage, while allowing for rich functionality of the online ads, but not the undesirable manipulation thereof by an unscrupulous host. The techniques and systems create a cross-domain frame in a host webpage (e.g., a cross-domain inline frame (IFrame)), which contains a secure environment by default (e.g., content inside the frame cannot interact with the host webpage). The host webpage comprises host ad-space, which can be of a size that accommodates an initial size of ad content inside the cross-domain frame (e.g., the host ad-space is the same height and width as the initial size of an ad to be inserted in the cross-domain frame). An inter-frame communications channel is created between the cross-domain frame and the host webpage. This channel can be used, for example, to send and receive messages, detect events inside the frame, and communicate requests from content inside the frame. An API may be utilized that communicates a host's parameters and restrictions for an ad to be hosted in the cross-domain frame.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a block diagram illustrating an exemplary embodiment of current online ad serving on a host webpage.

FIG. 2 is a block diagram illustrating an exemplary embodiment of secure online ad serving on a host webpage.

FIG. 3 is a flow chart illustrating an exemplary method of secure serving of an online ad on a host webpage.

FIG. 4 is a block diagram illustrating an exemplary embodiment of a rendering of secure frame on a host webpage.

FIG. 5 is a block diagram illustrating an exemplary embodiment of communication between a secure frame and a host webpage.

FIG. 6 is a block diagram illustrating an exemplary embodiment of a secure frame expanding and moving to accommodate interaction with an online ad.

FIG. 7 is a component block diagram illustrating an exemplary source code interface.

FIG. 8 is a component block diagram illustrating an exemplary source code interface.

FIG. 9 is an illustration of an exemplary computer-readable medium comprising processor-executable instructions configured to embody one or more of the provisions set forth herein.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

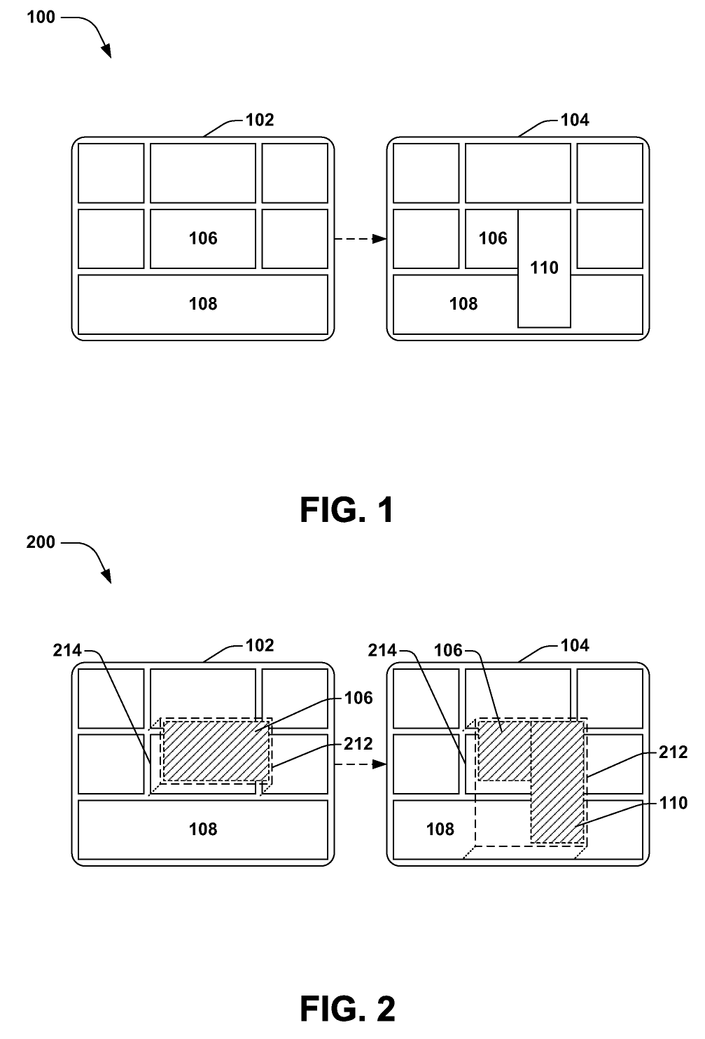

FIG. 1 is a block diagram illustrating an exemplary embodiment 100 of current online ad serving on a host webpage. In the exemplary embodiment 100, a host webpage 102 contains host content 108, and ad content 106 from a different domain than that of the host webpage 102. As an example, a host webpage 102 may call to an ad syndicator (e.g., an entity that provides online advertising services), which typically pulls an ad from an advertiser and puts the ad content 106 into the host webpage 102. The ad content 106 is typically inserted into the host webpage 102 so that a browser takes the ad content 106 as part of the host webpage 102. In this way, the ad content 106 may be allowed to freely interact with the host webpage for functionality, for example, allowing the ad to change its own size and position within the host webpage.

In FIG. 1, for example, when a user moves a cursor over the ad content 106, the ad expands 110 in the host webpage 104. The expanded ad content 110 covers over the host webpage content 108, in this example, as the browser considers the expanded ad content 110 to be part of the host webpage 104. In this exemplary embodiment of current online ad serving 100, an ad is granted respective privileges of the host webpage 104 in the browser. Therefore, ads that are “buggy” (e.g., do not work properly, will not close, shrink, etc.) or malicious (e.g., designed to steal personal information of users, or damage a host webpage), for example, may result in diminished or potentially harmful user experiences with the host webpage.

However, using the techniques and systems described herein, FIG. 2 illustrates an exemplary embodiment 200 of secure online ad serving on a host webpage. In the exemplary embodiment 200, a host webpage 102 contains ad space 214, which acts as a place holder for potential ads. In this embodiment, for example, an inline frame 212 (e.g., an inline, cross-domain frame comprising content from a different domain than that of the host webpage) can be inserted as a floating layer above the host webpage 102, aligned with the ad space 214. In this example, when the host webpage 102 calls to an ad syndicator to pull an ad from an advertiser, the ad content 106 can be inserted into the inline frame 212, instead of directly into the host webpage 102.

Because the ad content 106 is contained within the inline frame 212, for example, the ad may not be granted privileges of the host webpage102 in the browser, thereby providing a more secure environment for the host webpage 102. However, referring to FIG. 2, if the ad content 106 is configured to expand 110 (e.g., upon a mouse over by a user) the inline frame 212 may need to expand to accommodate the expanded ad content 110 in the host webpage 104. In this example, a secure communications channel may be created that allows the inline frame 212 to communicate requests (e.g., to expand or move the inline frame) to the host webpage 104. Upon receiving such a request, for example, the host webpage 104 can programmatically expand the inline frame 212 to accommodate the expanded ad content 110, which can float over the host content 108. In this way, functionality of the ad content can be accommodated, while security of the host webpage 104 may be maintained.

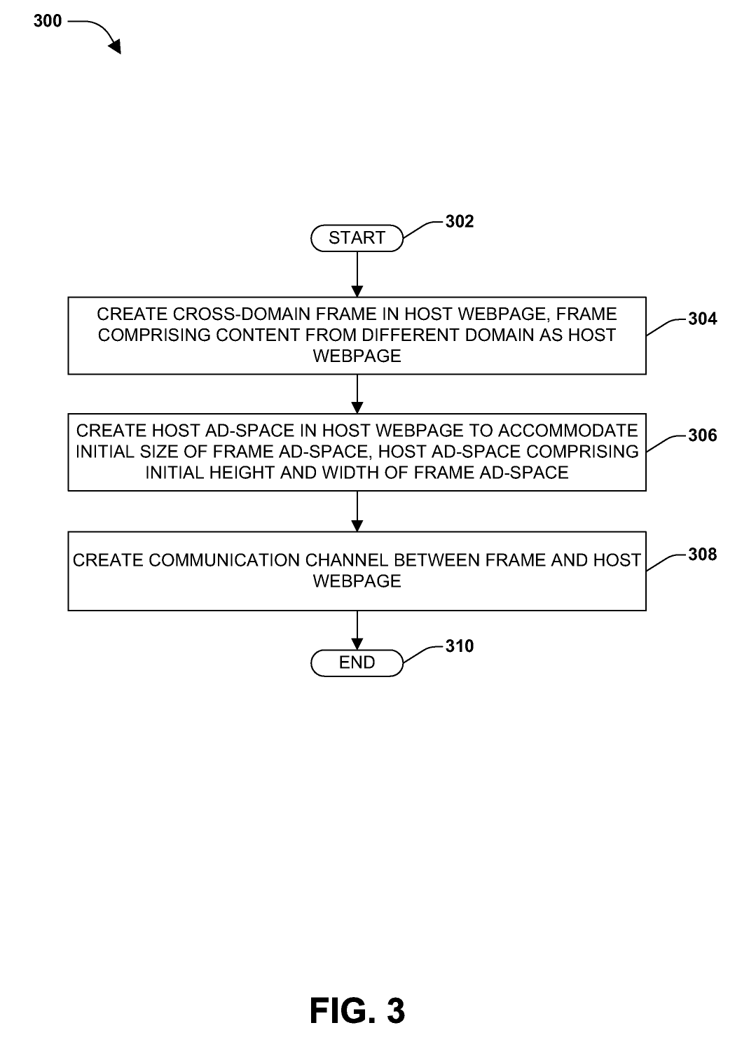

FIG. 3 is a flow chart illustrating an exemplary method 300 for secure serving of an online ad on a host webpage. The exemplary method 300 begins at 302 and involves creating a cross-domain frame in a host webpage, at 304, with the frame comprising content from a different domain than the domain of the host webpage. As an example, a cross domain frame may be an inline frame (IFrame) that is configured to contain an online ad created and hosted by a different domain than that of the host webpage. Further, in this example, the IFrame can be configured to be substantially isolated from the host webpage so that content inside the IFrame may not interact with content outside the IFrame (e.g., the ad content may not manipulate the host webpage and/or content thereon).

At 306, host ad-space is created in the host webpage to accommodate an initial size of a frame ad-space. The host ad-space comprises an initial height and width of the frame ad-space. As an example, the host webpage may create host ad-space comprising a specified width and height. In this example, the host webpage can call to an ad syndicator with the specified width and height, which can correspond to an initial width and height of an advertiser's ad content. In this way, the ad syndicator can pull only those ads that may have an initial width and height meeting the specifications of the host webpage. In this example, the host ad-space will not contain host content, so as to avoid conflicts with ad content. Further, the frame created at 304 to contain the ad content can initially be configured to the specified size of the host ad-space.

At 308, a communication channel is created between the cross-domain frame and the host webpage. As an example, a secure channel can be created between the cross-domain frame and the host webpage that allows the ad content in the frame to communicate requests to the host. In this example, if the ad content in the frame is configured to expand when a user moves a cursor over the ad content, a request can be sent to the host, over the secure channel, to expand the frame to accommodate the expanded ad content. Further, the host webpage may communicate with the frame's contents, over the secure channel, in order to configure display properties or other functionalities.

Having created a communication channel between the frame and the host webpage, the exemplary method 300 ends at 310.

In one aspect, isolating third-party online ads from a hosting webpage and/or website can provide security for the host webpage from malicious attacks, and provide users with a positive and secure online experience. In this aspect, for example, a floating transparent cross-domain frame can be utilized in the host web-page to isolate the ad content from the host web-page. The cross-domain frame may be inserted inline (e.g., an IFrame) in the host webpage, which has a default property of disallowing interaction between the content inside the frame and the ad hosting web page. Any necessary interaction between the ad content and the host webpage may be accomplished by means of a secure communications channel between the frame and the host webpage, as discussed later.

In this aspect, other related solutions to security of online ads (e.g., “BrowserShield,” “SafeScript,” “Google Caja”) utilize a “blacklisting” or a “whitelisting” method, whereby an ad is put into a same isolation boundary as a hosting webpage in a browser. In these related solutions, specified “unsafe” functionalities are then removed (blacklisted) from the ad content in the isolation boundary in the browser, or an ads' functionalities are restricted to a subset of what otherwise is provided by the browser to the ads by default (whitelisted). However, these solutions may not be attractive for ad syndicators, hosts and ad owners, as functionality can be reduced, and specific, proprietary updates may be necessary to the browser, and by the ad syndicator and ad owner.

Additionally, in this aspect, isolating third-party online ad content from a hosting webpage and/or website can provide security for the ad owner. The isolation techniques and systems, described herein, can inhibit the hosting website/webpage from programmatically manipulating the ad content inside the browser. For example, a webpage host may wish to forge user clicks (e.g., increase an amount of times user's (appear to) click on an ad) in order to increase an amount paid to the host by the ad owner (e.g., a type of click-fraud, whereby host's are paid more by ad owners when ads are clicked on more by users). In this way, a secure ad serving experience can be provided for both the host webpage and the ad owner or syndicator.

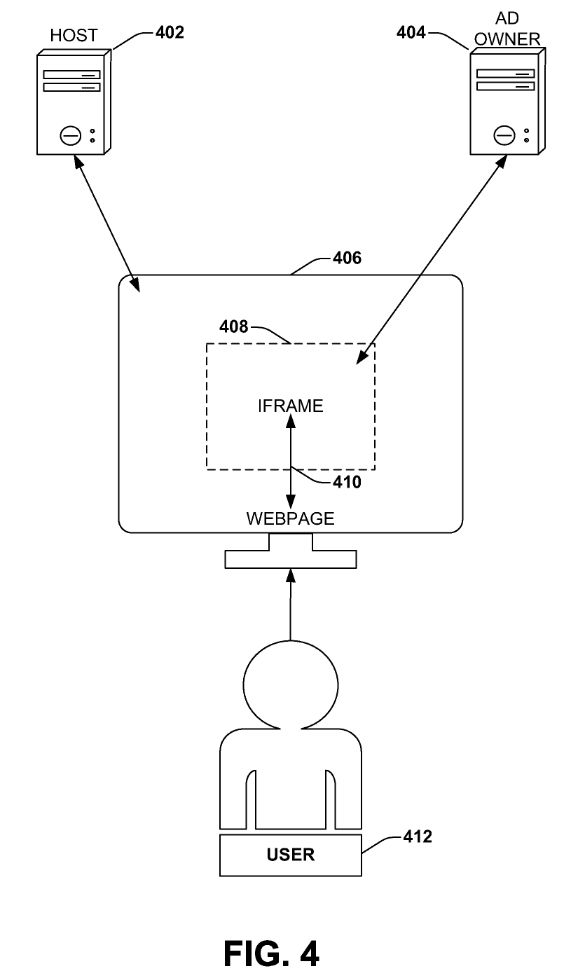

One embodiment of a use of a secure cross-domain frame (e.g., an IFrame) to isolate ad content is illustrated in FIG. 4. A website host 402 publishes a host webpage 406, for example, to the Internet, accessed and viewed by an online user 412. The website host 402 has all appropriate access and privileges for the host webpage 406. The host webpage 406 can, in this example, render an IFrame 408 inside (inline) the host webpage 406. By default, content inside the IFrame 408 cannot interact with the host webpage 406. In this example, the IFrame creates a substantial barrier between the frame's content and the host webpage 406, thereby mitigating malicious attacks originating from the frame's content, and mitigating a potential for the online user's 412 information being accessed by the frame's content.

An ad owner 404 can generate ad content that is intended to be displayed on the host webpage 406. In this example, the ad content generated by the ad owner 404 is inserted into the IFrame 408 in the host webpage 406. In this way, the ad owner 404 may merely have access to content inside the IFrame 408, and can be barred from interacting with the host webpage 406. However, in this example, a communications channel 410 may be created between the IFrame 408 and the host webpage 406, to aid in ad functionality, as discussed below.

In another aspect, ad content inside a cross-domain frame (e.g., a cross-domain inline frame (IFrame)) may need to communicate with a host webpage. As an example, ad content that is configured to expand upon a specified event (e.g., a mouseover the ad content) may not be able to expand due to a fixed size of the cross-domain frame. However, in this example, if the ad content could communicate an intention to expand to the host webpage, the host webpage may programmatically expand the cross-domain frame to accommodate the expanded ad content. Additionally, the host webpage may wish to communicate across to the frame in order to control display properties or other functionalities inside the frame. As an example, the host webpage may wish to display a title bar in the frame that displays the origin of the ad content.

In this aspect, an inter-frame communications channel (e.g., a flash channel) may be created that allows direct communication between the contents of the frame and the host webpage. However, because security of the host webpage may still be a concern if the ad content is able to communicate with the host webpage, techniques can be employed that provide a secure inter-frame communications channel. As an example, additional code may be inserted on either side of the communications channel, both inside the cross-domain frame and outside the frame, in the host webpage, that provides specified security measures.

In one embodiment, the security measures may call for “white-listing” communication functionalities for content inside the cross-domain frame. In this embodiment, only those functions the code deems to be “safe” may be “white-listed” (allowed to run) in the frame. As an example, the additional code can make anonymous event handlers undetachable inside the frame, ensuring that they cannot be changed or removed by an ads' code although they run together with the latter inside the frame. Further, in this example, JavaScript closure objects and functions can be used inside the frame. The “white-listing,” in this example, has an advantage over “black-listing” of prior solutions, as there is less of an open surface (e.g., less potential methods for a malicious attack or unauthorized use of information) in “white-listing.” Using “white-listing,” the host webpage provides a limited list of allowable functions, whereas “blacklisting” provides a list of disallowed functions.

Additionally, in this embodiment, the additional code can provide security for determining which communications may be allowed across the intra-frame communications channel. As an example, secret tokens may be generated that are shared between the codes inside and outside the frame. In this example, the code inside the frame will provide the secret token to those “white-listed” actions, thereby preventing ads' code from sending forged messages to the host web-page. Further, as an example, the additional code can send heart-beat messages across the channel to monitor the condition of the frame, to determine if the security code or measures inside the iframe is deactivated (e.g., when ads' code maliciously navigate the iframe away to another webpage). It will be appreciated that, while several examples of security measures have been discussed herein, the techniques described in this embodiment are not limited to any particular security measures. Those skilled in the art may devise additional methods and means for providing security to the intra-frame communications channel.

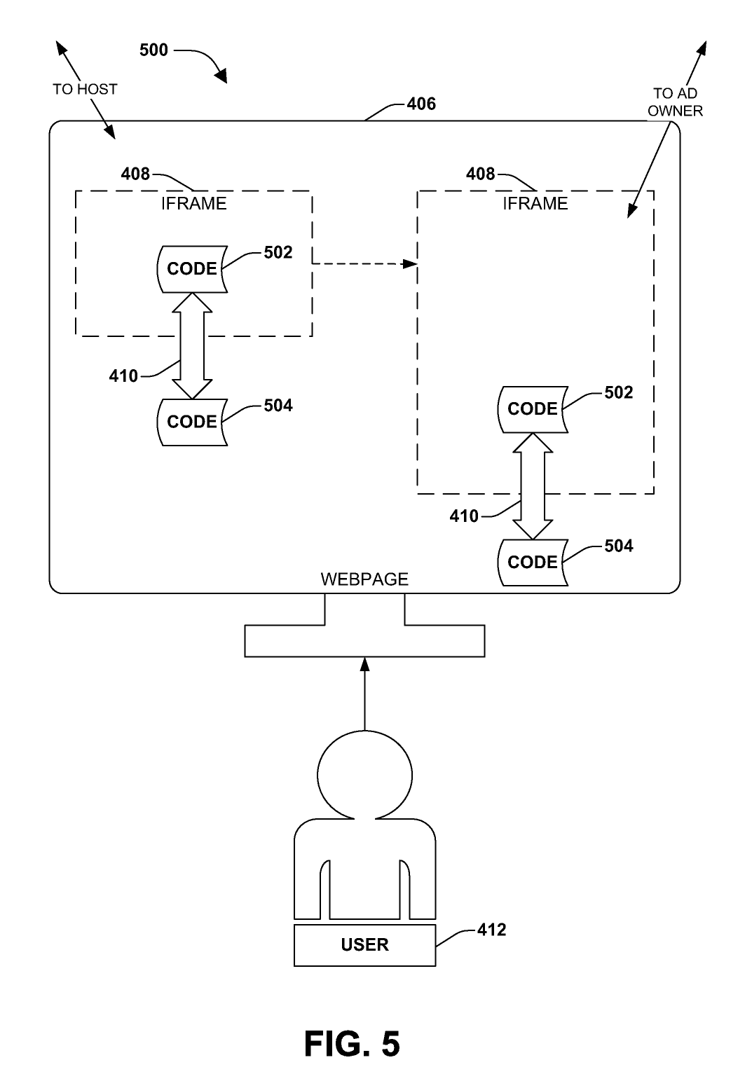

One embodiment of the use of an intra-frame communications channel for communicating between an IFrame, for example, and a host webpage is illustrated in FIG. 5. As previously illustrated in FIG. 4, now further detailed in the exemplary embodiment 500, a host webpage 406 communicates with a host website. In this example, the host website 406 comprises an IFrame 408 that receives ad content from an ad owner. As described above, in order for the ad content in the IFrame 408 to communicate with the host webpage 406 an inter-frame communications channel 410 is created between the IFrame 408 and the host webpage 406. Additional code 502 and 504 is inserted into the IFrame and the host webpage, which can determine a “white-list” of functions inside the IFrame 408 and provide for secure communications across the channel 410.

In this exemplary embodiment 500, a user 412 may interact with the ad content (e.g., mouseover) in the IFrame 408, which causes the ad content to expand. However, because the IFrame 408 may have a size that limits the ad content's expansion, the ad content may send a message across the communications channel 410 requesting that the host webpage expand the IFrame to accommodate the expanded ad content. As an example, one of the “white-listed” functions may be communicating frame expansions to the host webpage 406. In this example, because the function called by the ad content is “white-listed” the code 502 inside the IFrame 408 attaches a secret token to the message sent by the ad content across the channel 410, and the code 504 outside the IFrame receives the message with the secret token, thereby allowing the message to be passed to the host webpage 406. When the host webpage 406 receives the message it can, for example, programmatically expand the IFrame 408 to accommodate the expanded ad content.

In another aspect, events inside a cross-domain frame inserted into a host webpage (IFrame) may be detected to determine functionality of the IFrame and its content. As an example, the additional code inserted inside the IFrame may be used to detect events inside an IFrame such as a user's cursor movements, cursor location, moving a cursor over an element in the IFrame (mouseover, or mouse hover), or interacting with an element in the IFrame. Additionally, the code in the IFrame may be used, for example, to detect an ad content's user interface properties, that is, what types of functionality, display and interactive properties the ad content may have.

In this aspect, the additional code inside the frame can, for example, send messages outside the frame using the inter-frame communications channel concerning events detected inside the IFrame. In this way, as an example, change requests from the ad content, in response to events inside the IFrame, may be communicated to the host webpage. As described above, the additional code on the host webpage side of the communications channel may receive the messages and institute appropriately requested changes to the IFrame's properties, for example.

As an example, a user may move a cursor (mouse) from a position outside the IFrame to a position over ad content inside the IFrame. In this example, the code inside the IFrame can detect the cursor movement and location over the ad content, and it may receive a message from the ad content that this event results in the ad content expanding (e.g., or it may be a predetermined quality of the ad content, not needing a message). The code inside the IFrame can send a message across the channel to the code outside the IFrame, which can, in turn, change the IFrame properties to accommodate the expanded ad content inside the IFrame.

It will be appreciated that, while mouse and cursor events have been described in this embodiment, the techniques and systems, described herein, are not limited to these events and actions. In a computing environment, there are many varied events and actions that can occur on a webpage, and those skilled in the art may devise ways to detect these events and actions.

In another aspect, typical ad content utilizes expansion down and/or to the right, when viewed by a user. However, using a cross-domain inline frame (IFrame) one may not be limited to expansion in these directions when viewed on a webpage. As an example, the properties of an IFrame may be managed by the host webpage, and can be manipulated so that the IFrame expands and moves. In this example, an ad may be configured to expand upward when a user moves a cursor over the ad's content. If the IFrame can only expand downward, the expanded portion of the ad will not be viewed by the user, as the IFrame limits the ad's interaction with the host webpage. However, the IFrame may be made to expand to a size that accommodates the expanded ad content, move the expanded ad content to fit into the expanded IFrame, then move the IFrame to a position that, when viewed by the user, has an appearance that shows the ad content expanding upward (e.g., move the IFrame up). It will be appreciated that, the properties of an IFrame are not limited to expanding to accommodate an ad's expansion, but may include movement about the host webpage. An IFrame's properties can be controlled by the host webpage, and is only limited by the host's determined limitations.

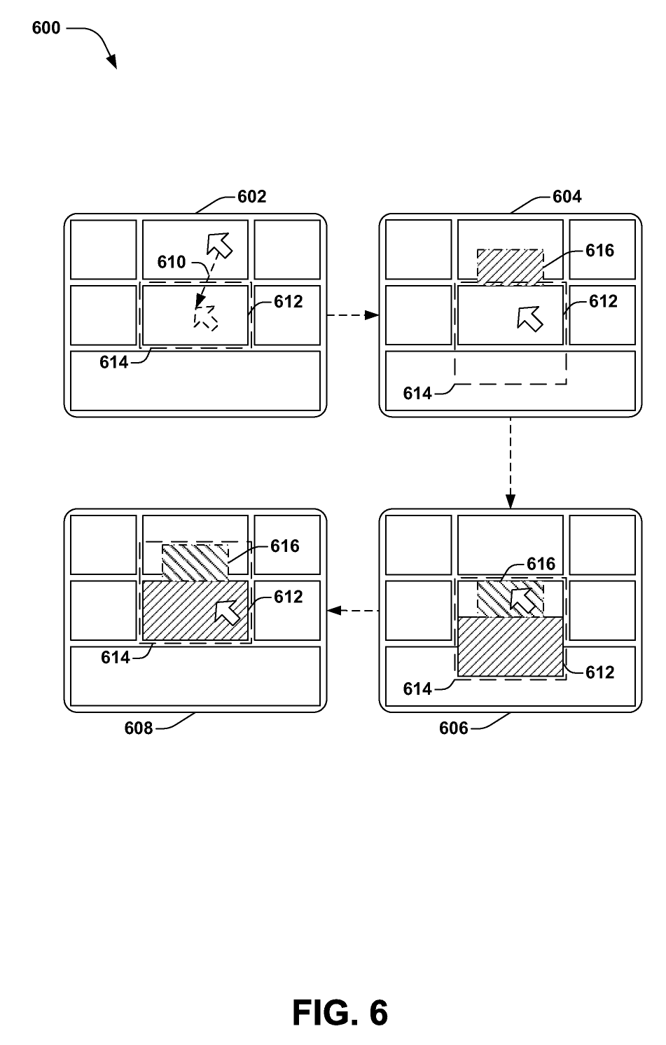

One embodiment of inter-frame event detection and frame expansion and movement is illustrated in FIG. 6. In the exemplary embodiment 600, a host webpage 602 comprises ad content 612 inside an IFrame 614. In this example, a user moves a cursor 610 over the ad content 612 in the IFrame 614. The ad content 612, in this example, is configured to expand upward when it detects the cursor moving 610 over the ad content 612. As seen in the host webpage 604, upon detecting the mouseover event 610, the ad content expands upward 616, and the code inside the IFrame sends a message across the inter-frame communication channel to the code in the host webpage, which expands the IFrame 614 to a size that accommodates the expanded ad content 616. However, because the ad content 612 and 616 is limited to display only inside the IFrame 614, the expanded ad content 616 cannot be viewed by the user.

In this exemplary embodiment 600, as seen in the host webpage 606, the code inside the IFrame can detect the expansion event, and move the ad content 612 and 616 down, to accommodate the expanded ad content 616 within the now expanded IFrame 614. However, in 606, the user would not experience the ad content expanding upward, as intended by the ad's configuration, but a jumping down and expansion of the ad content 612 and 616. As seen in host webpage 608, the code inside the IFrame 614 can detect the intended configuration event of the expanded ad content 616, and send a message to the code outside the IFrame 614 that requests the IFrame 614 be moved upward to accommodate the intended expansion. In this way, as viewed by the user, the ad content expands upward 616 from the original ad content 612 when the cursor is moved 610 over the ad content 612. It will be appreciated that the expansion and movement of the IFrame, in this example, can occur rapidly so that, as viewed by the user, the ad content merely expands upward.

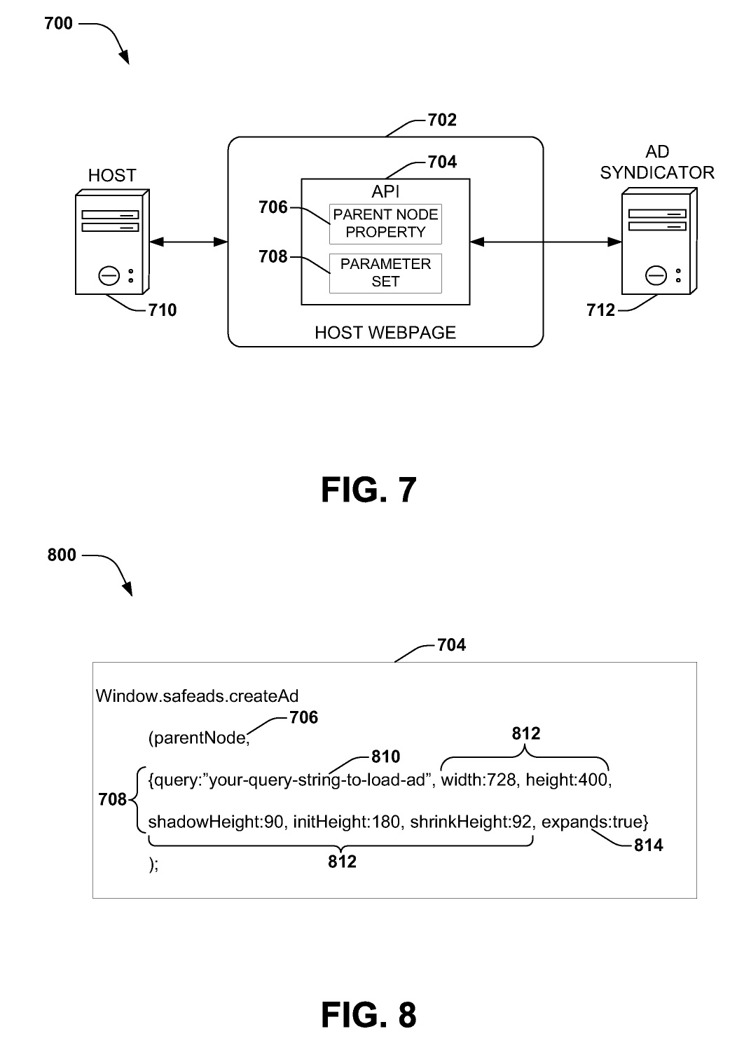

A source code interface (e.g., a set of application programming interfaces (APIs)) may be devised that provides an interface for a host webpage to communicate ad content parameters and restrictions to an ad syndicator. FIG. 7 illustrates an exemplary embodiment 700 of a source code interface. In the exemplary embodiment 700 a host webpage 702 has an instance of a source code interface 704 (e.g., an API) installed thereon. It will be appreciated that, while this exemplary embodiment 700 illustrates an instance of one API, a set of more than one APIs may be installed onto a host webpage comprising various parameters and/or restrictions related to displaying the ad on the host webpage.

In the exemplary embodiment 700, the source code interface 704 comprises a parent node property component 706, which is configured to direct an ad's parameters and/or restrictions to a parent node, for example, as provided by a host website. As an example, in order to configure child node elements of ad content one may use the parent node element (e.g., the parent element of the child elements) to enact configurations to the child node elements. The source code interface 704 further comprises a parameter set 708, which is configured to provide an ad's parameters and/or restrictions, for example, as provided by the host website. As an example, parameters comprising an ad's height, width, initial height, and minimum height may be provided by the host website, along with a restriction on whether the ad can expand inside an IFrame. In this example, the parameters and restrictions can be used when configuring the child node elements (e.g., those elements that correspond to the ad's parameters and restrictions) through the parent node element.

It will be appreciated that, while the exemplary embodiment 700 illustrates a use of a single API, comprising single instances of a parent node property component and a single instance of a parameter set component, the source code interface is not limited to this configuration. Multiple APIs may be utilized that contain one or more instances of parent node property components and one or more instances of parameter set components. As an example, there may be multiple elements that control parameters and configurations of an ad. Multiple instances of API may be used to, for example, describe the ad's authority to expand, it's orientation in an IFrame, and an extent the ad may be allowed to expand and/or move.

In this exemplary embodiment 700, a host 710 (e.g., a website that hosts an ad) can interact with the host webpage 702. The host can supply parameters and restrictions for an ad that may be hosted on the webpage 702, using the API 704. The parameters and restrictions, along with the parent node property, can be sent to the ad syndicator 712 where an ad, for example, can be configured to meet the requirements set forth by the host 710.

FIG. 8 illustrates an example of one embodiment 800 of the interface described above. In the exemplary embodiment 800, code for a primary API 704 is illustrated. The API 704 comprises a parent node property component 706 and a parameter set component 708. In this example, the parameter set component comprises a query to a code string for loading an ad 810. This code string for loading an ad 810 may comprise, for example, code that allows an ad from an ad syndicator to be loaded into an IFrame on the host webpage (e.g., 702, FIG. 7). The API 704 further comprises a list of parameters 812 that are used, for example, to describe an ad's dimensions (e.g., height, width) and maximum and minimum dimensions. As an example, a parameter 812 such as “initHeight” can be used to describe an ad's initial height when loaded into the IFrame. The API 704 further comprises a restriction set 814 that is used, for example, to describe an ad's ability to expand inside the IFrame.

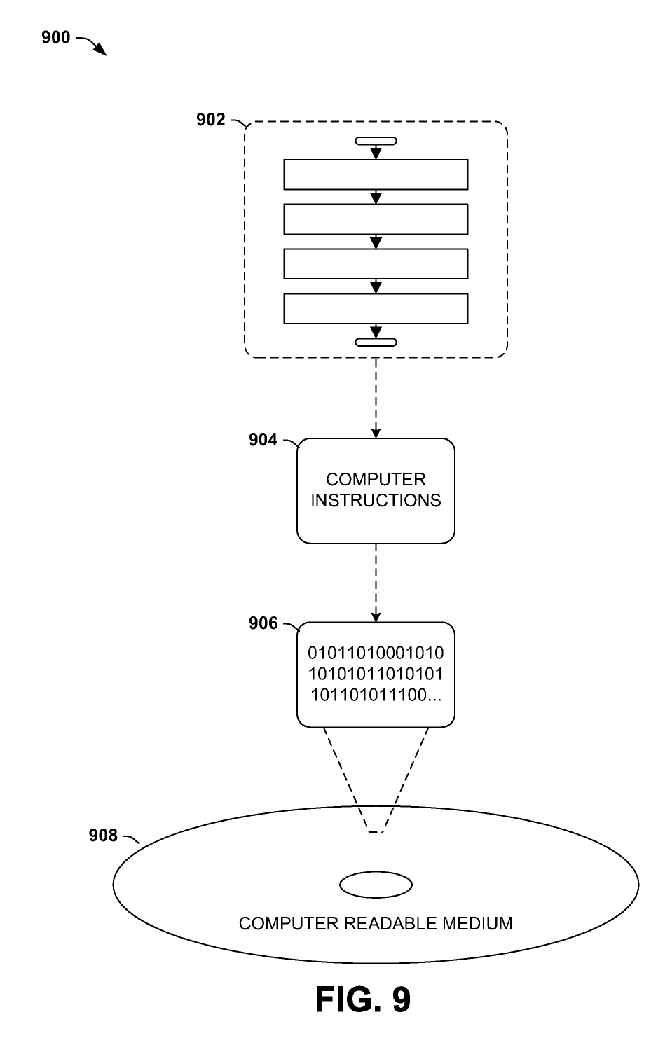

Still another embodiment involves a computer-readable medium comprising processor-executable instructions configured to implement one or more of the techniques presented herein. An exemplary computer-readable medium that may be devised in these ways is illustrated in FIG. 9, wherein the implementation 900 comprises a computer-readable medium 908 (e.g., a CD-R, DVD-R, or a platter of a hard disk drive), on which is encoded computer-readable data 906. This computer-readable data 906 in turn comprises a set of computer instructions 904 configured to operate according to one or more of the principles set forth herein. In one such embodiment 900, the processor-executable instructions 904 may be configured to perform a method, such as the exemplary method 300 of FIG. 3, for example. In another such embodiment, the processor-executable instructions 904 may be configured to implement a system, such as the exemplary system 700 of FIG. 7, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

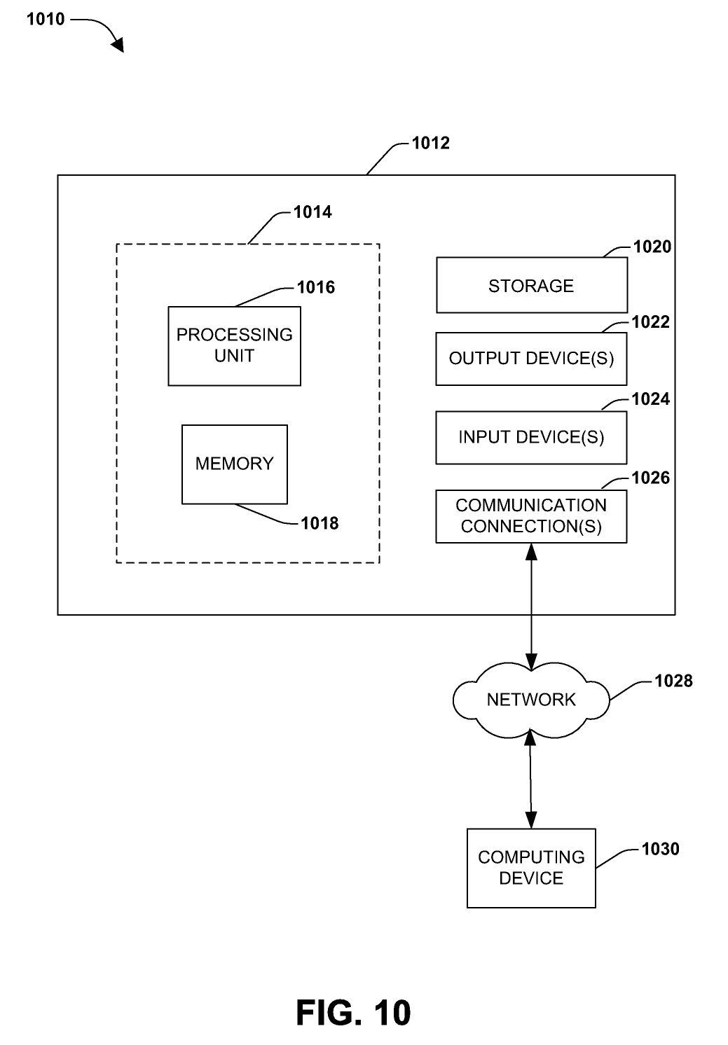

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 122 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for rendering online ads on a webpage, the method comprising:
creating a cross-domain frame in a host webpage, the frame comprising content from a different domain than the host webpage's domain;
creating host ad space in the host webpage to accommodate an initial size of a frame ad-space, the host ad space comprising an initial height and width of the frame ad-space; and
creating a inter-frame communication channel between the frame and the host web-page.

2. The method of claim 1, comprising inserting additional programming code for facilitating communication over the communication channel.

3. The method of claim 2, inserting additional programming code in the cross-domain frame.

4. The method of claim 2, inserting additional programming code in the host webpage.

5. The method of claim 2, the programming code comprising security programming code for providing security for the communication channel.

6. The method of claim 2, the programming code comprising a scripting language code.

7. The method of claim 1, securing the inter-frame communication channel comprising providing a list of allowed functionalities for content inside the cross-domain frame.

8. The method of claim 1, comprising detecting one or more events inside the frame using the frame programming code.

9. The method of claim 8, comprising the frame programming code communicating with the host programming code over the communication channel upon detection of the one or more events.

10. The method of claim 8, an event comprising one or more:
one or more user interactions; and
one or more mouse events.

11. The method of claim 8, comprising the host webpage resizing the frame within the host webpage in response to a request originating from inside the frame.

12. The method of claim 8, comprising the host webpage moving the frame within the host webpage in response to a request originating from inside the frame.

13. The method of claim 1, comprising coordinating the frame programming code with the host programming code to provide for frame functionality.

14. The method of claim 13, frame functionality comprising one or more of:
one or more frame display properties;
one or more frame utilities; and
one or more frame user interface functionalities.

15. An source code interface configured to provide a host webpage an interface for communicating ad content parameters and restrictions to an ad syndicator, the interface comprising:
one or more parent node property components configured to direct an ad's parameters and/or restrictions to a parent node; and
one or more parameter set components configured to provide an ad's parameters and/or restrictions.

16. The interface of claim 15, the source code interface comprising one or more application program interfaces (APIs).

17. The interface of claim 15, the parent node having one or more child nodes, the child nodes comprising elements for an ad's parameters and/or restrictions.

18. The interface of claim 15, the one or more parameter set components comprising one or more of:
a query to a code string for loading an ad;
the ad's parameters as configured by a host; and
the ad's restrictions as configured by a host.

19. The interface of claim 15, the ad's parameters comprising one or more of:
a maximum width of the ad;
a maximum height of the ad;
an initial height of the ad;
an initial width of the ad;
a minimum height of the ad;
a minimum width of the ad;
a height of a space in the host webpage that the ad can occupy; and
a width of a space in the host webpage that the ad can occupy.

20. A method for rendering online ads on a webpage, the method comprising:
creating a cross-domain frame in a host webpage, the frame comprising content from a different domain than the host webpage's domain;
creating host ad space in the host webpage to accommodate an initial size of a frame ad-space, the host ad space comprising an initial height and width of the frame ad-space;
creating a inter-frame communication channel between the frame and
the host web-page, comprising:
inserting additional programming code, comprising security programming code for providing security, for the communication channel for facilitating communication over the communication channel, the inserting comprising:
inserting additional programming code in the cross-domain frame; and
inserting additional programming code in the host webpage; and
securing the inter-frame communication channel comprising providing a list of allowed functionalities for content inside the cross-domain frame.
